(19) United States
(12) Patent Application Publication
(10) Pub. No.: US 2006/0134933 A1
(43) Pub. Date: Jun. 22, 2006

(54) Electrical connector assembly

(76) Inventor: Yea-Yen Huang, Hsin-Tien City (TW)

Correspondence Address: LADAS & PARRY, 26 WEST 61ST STREET, NEW YORK, NY, 10023, US

(21) Appl. No.: 11/301,158

(22) Filed: Dec. 12, 2005

(30) Foreign Application Priority Data
Dec. 21, 2004 (TW) 093139801

(51) Int. Cl. H01R 39/00

(52) U.S. Cl. 439/22

(57) ABSTRACT

An electrical connector assembly includes a first electrical connector having a first electrical contact unit provided on a coupling end portion of a first housing and connected electrically to a first conductive terminal unit that is mounted in the first housing. A second electrical connector includes a second housing having a coupling end portion connected pivotally to the coupling end portion of the first housing and rotatable about an axis relative to the coupling end portion of the first housing of the first electrical connector, a second conductive terminal unit mounted in the second housing, and a second electrical contact unit provided on the coupling end portion of the second housing, connected electrically to the second conductive terminal unit, and in electrical contact with the first electrical contact unit.

### CROSS-REFERENCE TO RELATED APPLICATION

This application claims priority of Taiwanese Application No. 093139801, filed on Dec. 21, 2004.

### BACKGROUND OF THE INVENTION

1. Field of the Invention

The invention relates to an electrical connector assembly, more particularly to an electrical connector assembly that has two electrical connectors connected rotatably to each other.

2. Description of the Related Art

Referring to FIG. 1, a wireless network card 1 is shown to include a base 11 having a pivot portion 14, and a main housing 13 connected pivotally to the pivot portion 14, pivotable relative to the base 11 about an axle (X) and provided with a wireless transceiver (not shown) therein. A conventional connector 12 is mounted on the base 11 and connected electrically to the wireless transceiver by means of wires (not shown). However, to prevent wire entanglement, rotation of the main housing 13 is preferably limited within a range from 0° to 270°.

### SUMMARY OF THE INVENTION

Therefore, the object of the present invention is to provide an electrical connector assembly that has two electrical connectors connected rotatably to each other.

According to the present invention, an electrical connector assembly comprises:

a first electrical connector including a first housing having a coupling end portion, a first conductive terminal unit mounted in the first housing, and a first electrical contact unit provided on the coupling end portion and connected electrically to the first conductive terminal unit; and

a second electrical connector including a second housing having a coupling end portion connected pivotally to the coupling end portion of the first housing and rotatable about an axis relative to the coupling end portion of the first housing of the first electrical connector, a second conductive terminal unit mounted in the second housing, and a second electrical contact unit provided on the coupling end portion of the second housing, connected electrically to the second conductive terminal unit, and in electrical contact with the first electrical contact unit of the first electrical connector.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional connector applied to a wireless network card;

FIG. 2 is a partly exploded perspective view showing the first preferred embodiment of an electrical connector assembly according to the present invention;

FIG. 3 is an exploded fragmentary view showing the second preferred embodiment of an electrical connector assembly according to the present invention;

FIG. 4 is a partly exploded perspective view showing the third preferred embodiment of an electrical connector assembly according to the present invention; and

FIG. 5 is a partly exploded perspective view of the fourth preferred embodiment of an electrical connector assembly applied to a wireless network card according to the present invention.

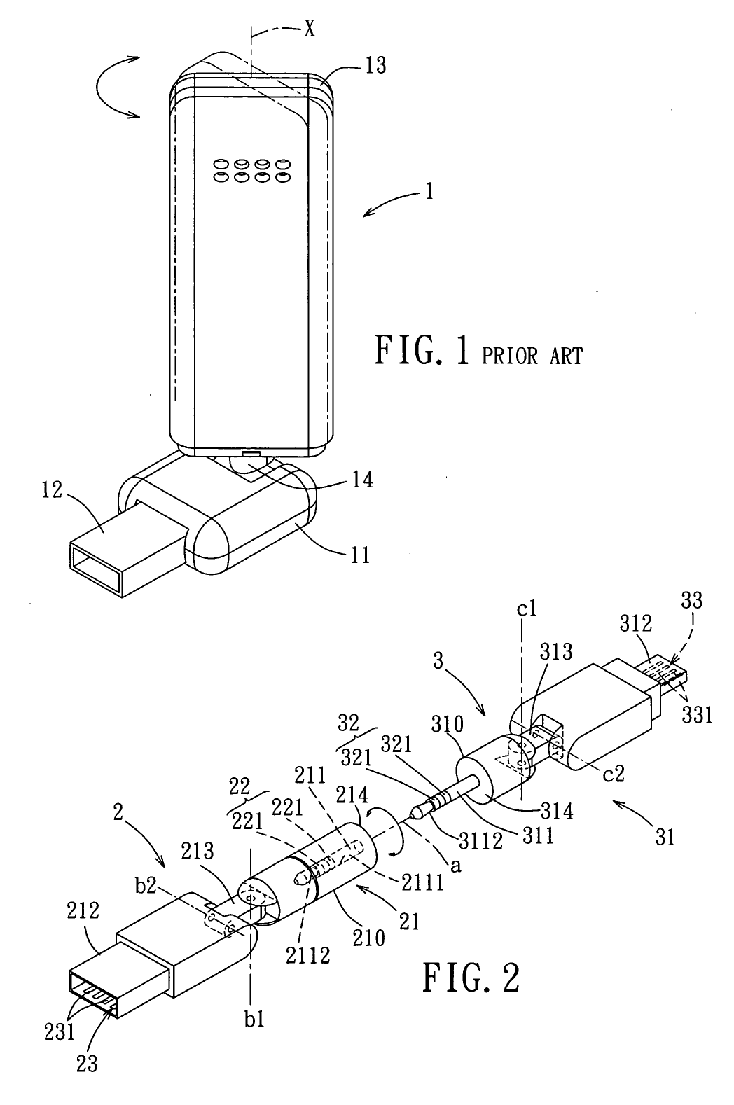

### DETAILED DESCRIPTION OF THE PREFERRED EMBODIMENTS

Before the present invention is described in greater detail, it should be noted that like elements are denoted by the same reference numerals throughout the disclosure.

Referring to FIG. 2, the first preferred embodiment of an electrical connector assembly according to the present invention is shown to include a first electrical connector 2 and a second electrical connector 3.

The first electrical connector 2 includes a first housing 21, a first conductive terminal unit 23, and a first electrical contact unit 22.

In the embodiment, the first housing 21 includes a coupling end portion 210, a connecting end portion 212 opposite to the coupling end portion 210, and an intermediate portion 213 interconnecting pivotally the coupling end portion 210 and the connecting end portion 212 such that the coupling end portion 210 is pivotable relative to the intermediate portion 213 about an axis (b1) and that the connecting end portion 212 is pivotable relative to the intermediate portion 213 about an axis (b2) perpendicular to the axis (b1). In this embodiment, the coupling end portion 210 of the first housing 21 has an end surface 214 perpendicular to an axis (a) and formed with a pivot hole 211 that extends along the axis (a) and that is defined by anannular inner surface 2111. The pivot hole 211 has a diameter-reduced intermediate portion 2112.

The first conductive terminal unit 23 is mounted in the first housing 21. In this embodiment, the first conductive terminal unit 23 includes a plurality of first conductive terminals 231 mounted in the connecting end portion 212 of the first housing 21. As such, in this embodiment, the connecting end portion 212 of the first housing 21 mounted with the first conductive terminals 231 can be in the form of a universal serial bus (USB) connecting port.

In this embodiment, the first electrical contact unit 22 includes a plurality of first conductive rings 221 disposed fixedly in the pivot hole 211 in the coupling end portion 210 of the first housing 21, mounted on the annular inner surface 2111 of the coupling end portion 210 of the first housing 21, and spaced apart from each other along the axis (a). The first conductive rings 221 of the first electrical contact unit 22 are connected electrically and respectively to the first conductive terminals 231 of the first conductive terminal unit 23 by means of wirings (not shown).

The second electrical connector 3 includes a second housing 31, a second conductive terminal unit 33, and a second electrical contact unit 32.

In this embodiment, the second housing 31 includes a coupling end portion 310, a connecting end portion 312 opposite to the coupling end portion 310, and an intermediate portion 313 interconnecting pivotally the coupling end portion 310 and the connecting end portion 312 such that the coupling end portion 310 is pivotable relative to the intermediate portion 313 about an axis (c1) and that the connecting end portion 312 is pivotable relative to the intermediate portion 313 about an axis (c2) perpendicular to the axis (c1). In this embodiment, the coupling end portion 310 of the second housing 31 has an end surface 314 facing the end surface 214 of the coupling end portion 210 of the first housing 21, perpendicular to the axis (a), and formed with a pivot shaft 311 that extends along the axis (a) and journalled within the pivot hole 211 in the end surface 214 of the coupling end portion 210 of the first housing 21. The pivot shaft 311 of the coupling end portion 310 has a diameter-reduced intermediate section 3112 engaging fittingly the diameter-reduced portion 2112 of the pivot hole 211 in the coupling end portion 210 of the first housing 21. As such, the coupling end portion 310 of the second housing 31 is connected pivotally to the coupling end portion 210 of the first housing 21, and is rotatable about the axis (a) relative to the coupling end portion 210 of the first housing 21 of the first electrical connector 2.

The second conductive terminal unit 33 is mounted in the second housing 31. In this embodiment, the second conductive terminal unit 33 includes a plurality of second conductive terminals 331 mounted in the connecting end portion 312 of the second housing 31. As such, in this embodiment, the connecting end portion 312 of the second housing 31 mounted with the second conductive terminal 331 can be in the form of a universal serial bus (USB) connecting port.

In this embodiment, the second electrical contact unit 32 includes a plurality of second conductive rings 321 sleeved fixedly on the pivot shaft 311, spaced apart from each other along the axis (a), and connected electrically and respectively to the second conductive terminals 331 of the second conductive terminal unit 33 by means of wirings (not shown). The second conductive rings 321 of the second electrical contact unit 32 contact electrically and respectively the first conductive rings 221 of the first electrical contact unit 22 when the pivot shaft 311 of the coupling end portion 310 of the second housing 31 is inserted into the pivot hole 211 in the coupling end portion 210 of the first housing 21.

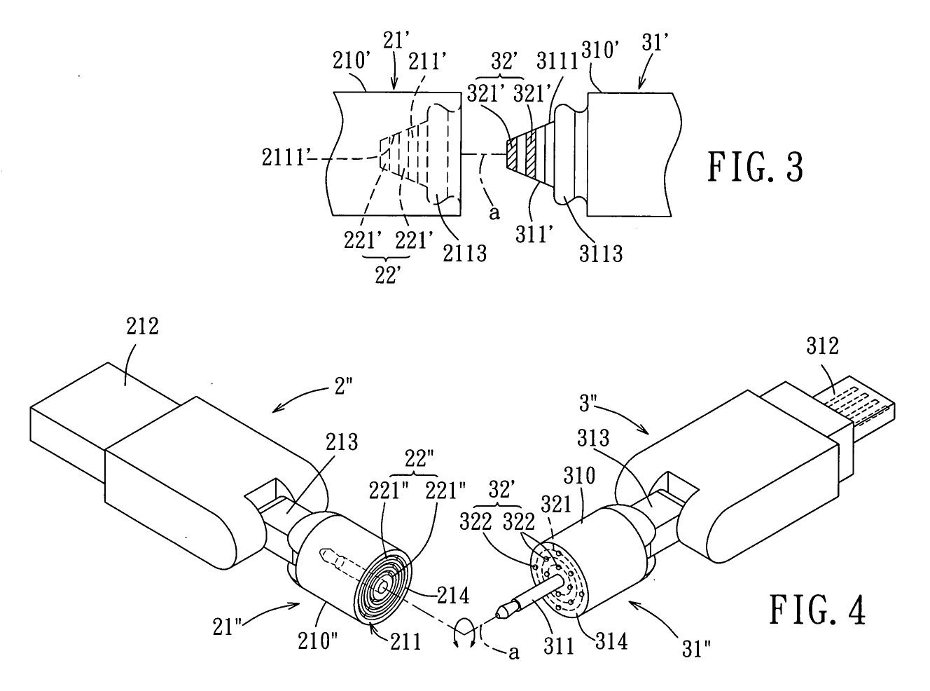

FIG. 3 illustrates the second preferred embodiment of an electrical connector assembly according to this invention, which is a modification of the first preferred embodiment. In this embodiment, each of the pivot hole 211′ in the coupling end portion 210′ of the first housing 21′ and the pivot shaft 311′ of the coupling end portion 310′ of the second housing 31′ is truncately conical.

The annular inner surface 2111′ of the coupling end portion 210′ of the first housing 21′ is formed with an annular engaging groove 2113. The pivot shaft 311′ of the coupling end portion 310′ of the second housing 31′ has an outer circumferential surface 3111 formed with an annular engaging rib 3113 engaging fittingly the engaging groove 2113 when the pivot shaft 311′ of the coupling end portion 310′ of the first housing 31′ is inserted into the pivot hole 211′ in the coupling end portion 210′ of the first housing 21′.

FIG. 4 illustrates the third preferred embodiment of an electrical connector assembly according to this invention, which is a modification of the first preferred embodiment. In this embodiment, the first electrical contact unit 22″ includes a plurality of concentric conductive rings 221″ mounted spacedly on the end surface 214 of the coupling end portion 210″ of the first housing 21″. The second electrical contact unit 32″ includes a plurality of groups of electrical contacts 322 mounted on the end surface 314 of the coupling end portion 310 of the second housing 31″. The electrical contacts 322 of each group are distributed along a circumference direction of the conductive rings 221″ of the first electrical contact unit 22″, and contact electrically a respective one of the conductive rings 221″ of the first electrical contact unit 22″.

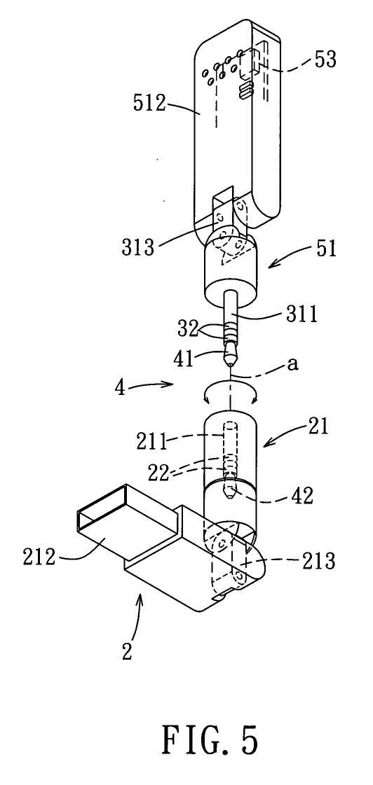

FIG. 5 illustrates the fourth preferred embodiment of an electrical connector assembly according to this invention, which is a modification of the first preferred embodiment. In this embodiment, the connecting end portion 512 of the second housing 51 of the second electrical connector 5 further houses a circuit unit 53, which functions as a wireless network card, having the second conductive terminal unit (not shown).

In such a configuration, the first electrical contact unit 22, 22′, 22″ of the first electrical connector 2, 2′, 2″ contacts electrically the second electrical connector 3, 3′, 3″, 5 even when the second housing 31, 31′, 31″, 51 rotates relative to the first housing 21, 21′, 21″ about the axle (a). Therefore, the electrical connector assembly of this invention can be used without wire entanglement.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An electrical connector assembly comprising:
a first electrical connector including a first housing having a coupling end portion, a first conductive terminal unit mounted in said first housing, and a first electrical contact unit provided on said coupling end portion and connected electrically to said first conductive terminal unit; and
a second electrical connector including a second housing having a coupling end portion connected pivotally to said coupling end portion of said first housing and rotatable about an axis relative to said coupling end portion of said first housing of said first electrical connector, a second conductive terminal unit mounted in said second housing, and a second electrical contact unit provided on said coupling end portion of said second housing, connected electrically to said second conductive terminal unit, and in electrical contact with said first electrical contact unit of said first electrical connector.

2. The electrical connector assembly as claimed in claim 1, wherein said coupling end portion of said first housing of said first electrical connector has an end surface perpendicular to the axis and formed with a pivot hole that extends along the axis and that is defined by an annular inner surface, said coupling end portion of said second housing of said second electrical connector having an end surface facing said end surface of said coupling end portion of said first housing, perpendicular to the axis and formed with a pivot shaft that extends along the axis and journalled within said pivot hole in said end surface of said coupling end portion of said first housing.

3. The electrical connector assembly as claimed in claim 2, wherein said first electrical contact unit includes a plurality of first conductive rings disposed fixedly in said pivot hole, mounted on said annular inner surface of said coupling end portion of said first housing, and spaded apart from each other along the axis, said second electrical contact unit including a plurality of second conductive rings sleeved fixedly on said pivot shaft, spaced apart from each other along the axis, and contacting electrically and respectively said first conductive rings of said first electrical contact unit.

4. The electrical connector assembly as claimed in claim 2, wherein said pivot hole in said coupling end portion of said first housing has a diameter-reduced intermediate portion, said pivot shaft of said coupling end portion of said second housing having a diameter-reduced intermediate section engaging fittingly said diameter-reduced intermediate portion of said pivot hole.

5. The electrical connector assembly as claimed in claim 2, wherein each of said pivot hole in said coupling end portion of said first housing and said pivot shaft of said coupling end portion of said second housing is truncately concial.

6. The electrical connector assembly as claimed in claim 5, wherein said annular inner surface of said coupling end portion of said first housing is formed with an annular engaging groove, said pivot shaft of said coupling end portion of said second housing having an outer circumferential surface formed with an annular engaging rib engaging fittingly said engaging groove.

7. The electrical connector assembly as claimed in claim 2, wherein said first electrical contact unit includes a plurality of concentric conductive rings mounted spacedly on said end surface of said coupling end portion of said first housing, said second electrical contact unit includes a plurality of groups of electrical contacts mounted on said end surface of said coupling end portion of said second housing, said electrical contacts of each of groups being distributed along a circumference direction of said conductive rings of said first electrical contact unit and contacting electrically a respective one of said conductive rings of said first electrical contact unit.

8. The electrical connector assembly as claimed in claim 1, wherein:
said first housing of said first electrical connector further includes a connecting end portion opposite to said coupling end portion and provided with said conductive terminal unit therein, and an intermediate portion interconnecting pivotally said coupling end portion and said connecting end portion of said first housing such that each of said coupling end portion and said connecting end portion of said first housing is pivotable relative to said intermediate portion of said first housing; and
said second housing of said second electrical connector further includes a connecting end portion opposite to said coupling end portion of said second housing and provided with said second conductive terminal unit therein, and an intermediate portion interconnecting pivotally said coupling end portion and said connecting end portion of said second housing such that each of said coupling end portion and said connecting end portion of said second housing is pivotable relative to said second intermediate portion of said second housing.
